(19) United States
(12) Patent Application Publication
(10) Pub. No.: US 2009/0019669 A1
(43) Pub. Date: Jan. 22, 2009

(54) POSITIVE WHEEL LOCKING MECHANISM

(76) Inventors: Dennis E. Jones, Stevensville, MI (US); Patrick Allen Peck, JR., Stevensville, MI (US); Roy Edward Masters, JR., Benton Harbor, MI (US)

Correspondence Address: Patent Department;DLA PIPER US LLP, Suite 1900, 203 North LaSalle Street, Chicago, IL, 60601, US

(21) Appl. No.: 11/780,924

(22) Filed: Jul. 20, 2007

(51) Int. Cl. B60B 33/00

(52) U.S. Cl. 16/35 R

(57) ABSTRACT

A locking mechanism system for a caster or similar wheeled device. The subject caster or the like is provided with a wheel containing a plurality of detents or grooves that is mounted to a fork having an aperture. The locking mechanism is mounted to the fork such that a retractable locking pin may move in and out of the aperture. A slidable lever, containing an internal cam moves the spring biased locking pin between an unlocked and locked position such that the locking pin engages the wheel detents in the locked position, thus preventing the wheel from rotating.

### BACKGROUND OF THE INVENTION

1. Field of Invention

This invention finds use in the field of brakes for wheels and more particularly brakes for casters and other wheels for furniture and similar articles.

2. Background

The use of braking mechanisms on casters and similar wheeled articles is well known, with differing approaches utilized historically. A great many of such solutions generally rely upon the friction between the wheel and the brake member. One such approach is the use of a thumb screw brake that is actuated by manual rotation of a threaded member, supported by the caster body, that engages the outer surface of the wheel. This creates sufficient friction to inhibit rolling (limited by the frictional force applied) of the wheel and thus a product supported by such casters. Such thumb screw type brakes can be difficult to engage and disengage.

A second approach is a “tread brake” mechanism where the brake unit is manually actuated, generally by a cam mechanism, to extend a member from the caster frame to contact the rolling surface (tread) of the wheel with sufficient force that the corresponding friction limited the rolling of the wheel. While such brakes are easier to engage and disengage than a thumb brake, they are limited by the friction created by the brake contacting the wheel tread and are vulnerable to tread wear during the life of the caster. Tread wear reduces wheel size, brake member engagement and therefore the applied friction to the wheel tread.

A third type of brake design is the use of an internal brake between two wheels or wheel portions, such as is shown in U.S. Pat. Nos. 5,988,323 to Chu and 6,360,851 to Yang. The wheels are mounted to the outside of the body and an internal shaft or clip engages cogs within such wheel elements. While this type of design does prevent movement of the wheel and does not cause tread wear to the wheel, it utilizes a complex actuation mechanism that is more prone to breakage and is difficult to repair. Installation can also be difficult. Further, such designs can only be utilized with dual or split wheel designs, and not with single wheels, such are commonly used with casters.

### BRIEF DESCRIPTION OF THE DRAWINGS

Specific embodiments of the invention have been chosen for purposes of illustration and description, and are shown in the accompanying drawing, forming a part of the specification wherein:

FIG. 1 is a perspective view of a caster assembly according to the invention without the locking mechanism;

FIG. 2 is a perspective view of a caster assembly according to the invention with the locking mechanism;

FIG. 3 is a top, cutaway view of the caster and locking assembly according to the invention with the lock in a disengaged position;

FIG. 4 is a top, cutaway view of the caster and locking assembly according to the invention with the lock in an engaged position;

FIG. 5 is a perspective view of the locking mechanism according to the invention in a disengaged position;

FIG. 6 is a perspective view of the locking mechanism according to the invention in an engaged position;

FIG. 7 is a perspective, cutaway view of the locking mechanism according to the invention in a disengaged position; and

FIG. 8 is a perspective, cutaway view of the locking mechanism according to the invention in an engaged position.

### DESCRIPTION OF PREFERRED EMBODIMENTS

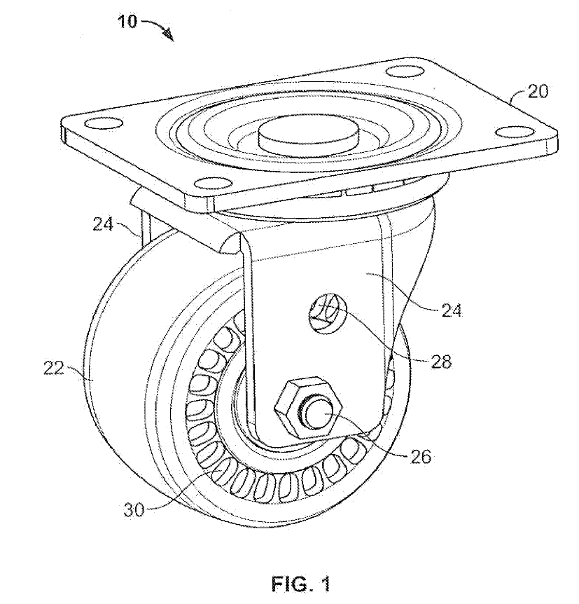

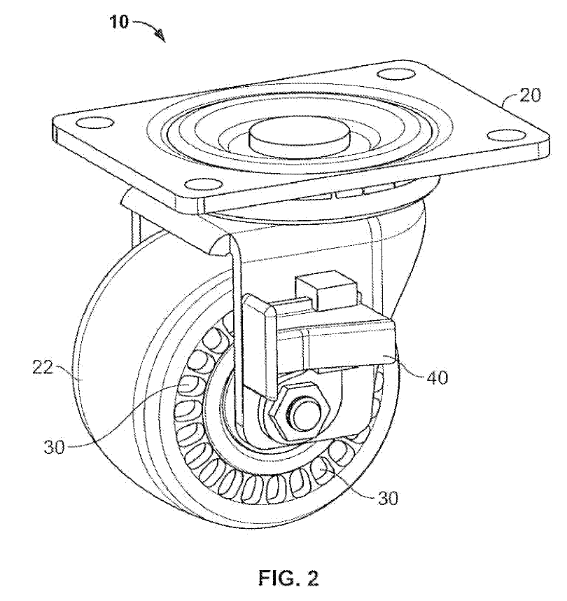

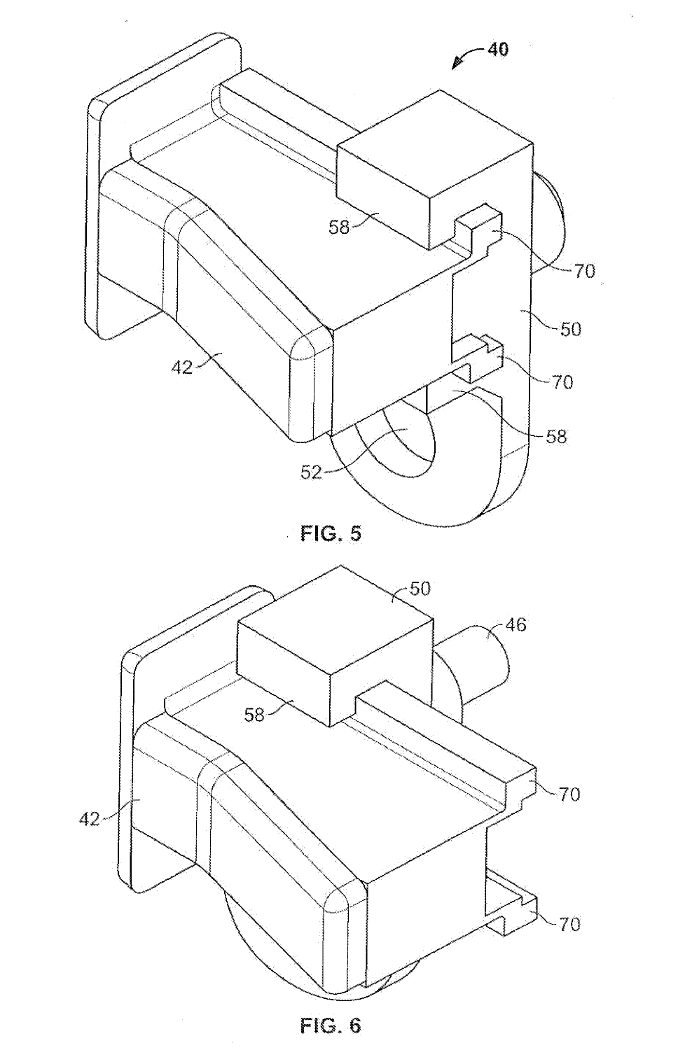

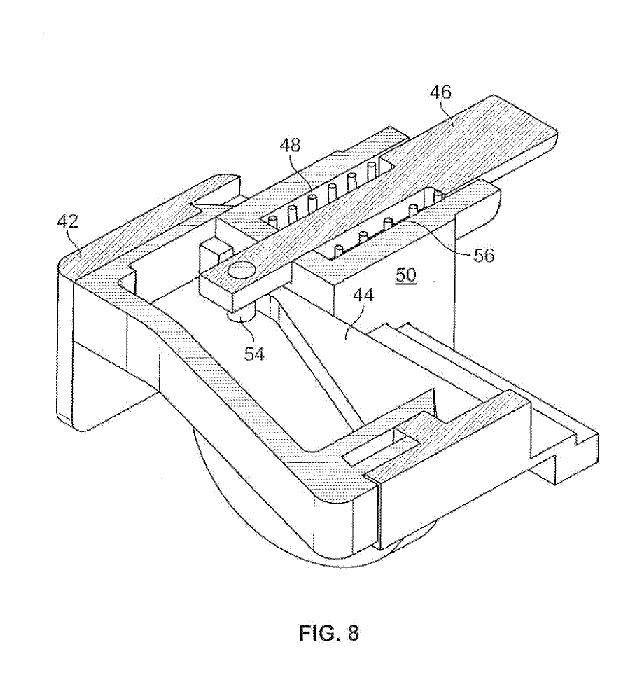

Referring now the FIGS. 1 and 2, the general structure of the inventive wheel locking mechanism is shown in conjunction with a representative caster 10. Caster 10 generally comprised a base 20 attached to a fork or other retaining structure 24 to which wheel 22 is attached by bolt 26. Fork 24 rotates about base 20 by way of bearings or other rotating means as is generally well understood in the art. Additional attachment means known in the art, such as axles, may be utilized in addition to or in lieu of the fork. Wheel 22 may be of a one-piece design or may be constructed of multiple parts, as is known in the art. Further, wheel 22 may alternatively be two separate wheels. In any embodiment, wheel 22 contains a plurality of detents, grooves, ridges or the like 30 that engage the brake mechanism 40 as described herein. As shown in the Figures, the detents are located on the side surfaces of the wheel, but alternatively may be located on the rolling surface. As is shown in FIG. 1, Fork 24 contains at least one aperture 28 into which the pin 46 of brake 40 is adapted to fit and actuate through in this embodiment. As can be seen in FIG. 2, brake mechanism is attached to the form 24 by way of bolt 26 (through ring 52, see FIGS. 5 and 7). In alternative embodiments, the aperture is not present and the locking mechanism can be mounted such that the operable structure is outside of the fork.

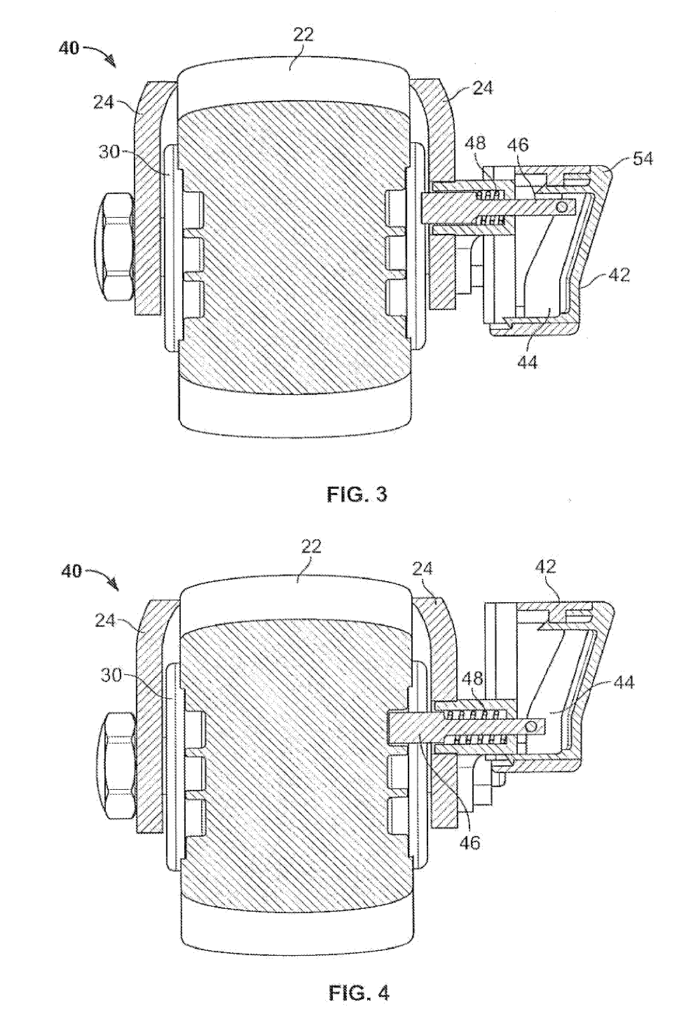

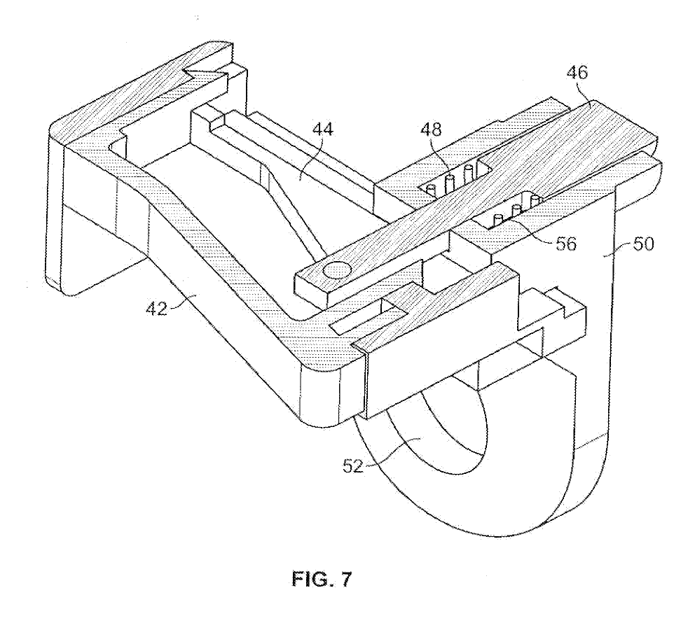

The structure and function of brake 40 is best seen with reference to FIGS. 3-8. Brake 40 is generally comprised of body 50, lever or actuator 42. Body 50 is preferably constructed of metal, for sturdiness, longevity, and support, but other materials may certainly be used. Locking pin 46 is retained within cavity 56 of body 50 and is biased outwardly by spring 48, as is shown in FIGS. 4, 6 and 8. Locking pin 54 further contains a cam follower pin portion 54 on the distal (lever side) portion. The body portion 50 is permanently mounted to lever 42 by way of u-shaped overhangs 58 that slidably mount to rails 70 on the lever.

Lever 42 is internally hollow and contains cam 44, best seen in FIGS. 3, 4, 7 and 8. Locking pin 46, by way of cam follower pin 54, is moved from an unlocked position (FIGS. 3, 5 and 7) to a locked position (FIGS. 4, 6 and 8) by moving the lever 42 such that the cam follower pin is biased against the cam, thus allowing the cam follower pin to move inward (towards the wheel 22) and relaxing the spring 48. The locking pin 46 is moved into an unlocked position by moving the lever 42 in the opposite direction, such that the cam follower pin 54 is moved away from the wheel by the cam and the spring is compressed. The cam follower pin 54 may optionally be retained in a clip, detent or other retaining means (not shown) on the bottom and top of the cam 44 when in the locked or unlocked position, respectively.

As can best be seen in FIGS. 3 and 4, locking pin 46 engages detents 30 of wheel 22 when in a locked position. The wheel 22 is therefore held in a static position by the locking pin 46. When in the unlocked position, locking pin 46 is withdrawn from the particular detent 30 and the wheel 22 is thus free to rotate.

In addition to the structures, sequences, and uses immediately described above, it will be apparent to those skilled in the art that other modifications and variations can be made the method of the instant invention without diverging from the scope, spirit, or teaching of the invention. Therefore, it is the intention of the inventor that the description of instant invention should be considered illustrative and the invention is to be limited only as specified in the claims and equivalents thereto.

We claim:

1) A brake for a wheel having a surface and rotatably mounted to a retaining structure comprising:
a) plurality of detents on the wheel surface;
b) a brake assembly attached to said retaining structure, the brake assembly comprising:
a body portion having an internal cavity in communication with first and second openings and further having a spring therein;
a lever slidably mounted to said second end of the body, said lever having an internal portion containing a cam; and
a locking pin having first and second ends, said locking pin mounted within said cavity and biased in said cavity by the spring, and having a transverse cam follower pin mounted on said second end and in communication with the cam, wherein said first end of the locking pin extends through said first body opening,
whereby the movement of said lever moves the locking pin from a retracted position to a extended position by way of said cam follower pin engaging the cam such that the first end of the locking pin engages one of the plurality of detents, thereby retaining the wheel in a locked position and movement of said lever in the opposite direction withdraws said locking pin from the detent thereby allowing the wheel to freely rotate.

2) The brake of claim 1 wherein the wheel has a rolling surface and a two side surfaces in communication with said rolling surface and wherein said detents are located on at least one of the side surfaces.

3) The brake of claim 1 wherein the retaining structure is a fork containing an aperture therethrough adapted to receive said first end of the locking pin, whereby said locking pin passes through said aperture and engages one of the plurality of detents when in the locked position.

4) The brake of claim 1 wherein said retaining structure is rotatably mounted to a base.

5) The brake of claim 1 wherein said body contains at least one raid and said lever is mounted to said at least one rail.
